(19) United States
(12) Patent Application Publication
(10) Pub. No.: US 2007/0153519 A1
(43) Pub. Date: Jul. 5, 2007

(54) Apparatus and method for providing a reverse hand-painted decorative fragrance lamp

(76) Inventors: James P. Sexton, Hickory Creek, TX (US); Michael P. Thalasinos, Flower Mound, TX (US)

Correspondence Address: LAW OFFICES OF JAMES E. WALTON, PLLC, 1169 N. BURLESON BLVD., SUITE 107-328, BURLESON, TX, 76028, US

(21) Appl. No.: 11/325,799

(22) Filed: Jan. 5, 2006

(51) Int. Cl. F21V 33/00

(52) U.S. Cl. 362/253

(57) ABSTRACT

An apparatus and method is disclosed for providing a reverse hand-painted decorative fragrance lamp. The decorative fragrance lamp comprises at least one glass vessel, at least one access port associated with an interior portion of the at least one glass vessel, a protective barrier disposed within the at least one glass vessel, and a ring coupled to the protective barrier and the at least glass vessel. The decorative fragrance lamp further comprising the at least one glass vessel capable of being reverse hand-painted on the interior portion through the at least one access port.

### BACKGROUND

1. Field of the Invention

The present invention relates generally to reverse hand-painted glass articles and, more specifically, to an apparatus and method for providing a reverse hand-painted decorative fragrance lamp.

2. Description of Related Art

The art of glass fabrication using various glass blowing techniques is an ancient art form. A typical glass fabricating method may be performed by a glass blower and may include various glass forming techniques such as hand blown, mouth blown, or molded glass techniques. Over the years, the talents of glass blowers have combined their glass-blowing talents with the talents of various other artists to create new forms of art. In particular, a skilled group of artists known as “reverse hand-painting artists” have combined their talents with those of the glass blowers to form hollow glass objects in the shape of decorative glass ornaments. The reverse hand-painting artists utilize their skills by hand-painting beautiful images on the inside of the glass-blown decorative glass ornaments. It is not uncommon for reverse hand-painting artists to differentiate their work from other artists by etching or reverse hand-painting their signature into the decorative glass ornaments. This process authenticates their art from other reverse hand-painting artists.

In addition, glass blowers have utilized their glass-blowing techniques to produce glass articles for use in fragrance lamps. Fragrance lamps contain fuel to produce a catalytic burner process that releases fragrances into the air. However, one problem with these fragrance lamps is that when the fuel is stored in the glass base, aesthetic appeal of the lamp is diminished. This limitation greatly reduces the usability of the fragrance lamp and greatly reduces the aesthetic appearance of glass bases associated with these fragrance lamps. Furthermore, the interior portion of the glass bases must remain free of any image or design elements, as for example, reverse hand-painting art, because the fuel would affect the physical and visual appearance of these elements by degrading, eroding, or otherwise adversely affecting the reverse hand-painted art.

Although great strides have been made in the area of fragrance lamps, many short comings remain.

### SUMMARY OF THE INVENTION

There is a need in the art for providing an apparatus and method for providing a reverse hand-painted decorative fragrance lamp. There is also a need for providing fuel to the reverse hand-painted decorative fragrance lamp without the fuel making direct contact with the interior portions of the decorative fragrance lamp. Therefore, it is an object of the present invention to provide an apparatus and method for providing a reverse hand-painted decorative fragrance lamp.

This object is achieved by providing a decorative fragrance lamp comprising at least one glass vessel and at least one access port associated with an interior portion of the at least one glass vessel. According to the preferred embodiment of the present invention, the decorative fragrance lamp comprises a protective barrier disposed within the at least one glass vessel and a ring coupled to the protective barrier and the at least one glass vessel.

According to another embodiment of the present invention, the decorative fragrance lamp further comprises an image disposed on an interior surface of the at least one glass vessel, wherein the image is a reverse hand-painted image painted through the at least one access port.

It is another object of the present invention to provide a system for providing a reverse hand-painted decorative fragrance lamp.

This object is achieved by providing a painted vessel comprising a hollow article, at least one access port for providing access to the interior of the hollow article, an image disposed on the interior surface of the hollow article, and a protective barrier disposed within the hollow article.

According to another embodiment of the present invention, the protective barrier is a liner and the painted vessel further comprises a ring coupled to the liner and the hollow article, a catalytic stone burner and wick assembly capable of being inserted into the hollow article through the top portion of the ring, a decorative crown comprising a plurality of venting ports, and a cap capable of coupling to the exterior top portion of the ring for snuffing out the catalytic burning process of the catalytic stone burner.

It is still another object of the present invention to provide a method for making a decorative fragrance lamp.

This object is achieved by providing a method comprising the steps of heating a first glass material, blowing the first glass material to form a hollow glass vessel, forming a base of the glass vessel, forming an access port in the glass vessel, inserting a liner through the access port of the glass vessel, and attaching the liner to the glass vessel by coupling a ring to the liner and the access port of the glass vessel.

According to another embodiment of the present invention, the method includes decorating the glass vessel by reverse hand-painting an image on an interior surface of the glass vessel, inserting a catalytic stone burner and wick assembly into the interior top portion of the ring, placing a cap on the exterior top portion of the ring, and providing a decorative crown to attach to the top portion of the decorative fragrance lamp.

The present invention provides the following advantages: (1) a liner capable of forming a protective barrier between the interior portion the decorative fragrance lamp and the fuel; (2) provides non-direct contact by the liner to separate the fuel from the image and allows the image to retain its original image properties; (3) greatly increases the usability of the decorative fragrance lamp; and (4) provides a more aesthetically pleasing decorative fragrance lamp, from a visual perspective.

These and other advantages and features of the present invention will become readily apparent to those skilled in the art upon examination of the subsequent detailed description and accompanying drawings. Accordingly additional advantages and features of the present invention and the scope thereof are pointed out with particularity in the claims and form a part hereof.

### DESCRIPTION OF THE DRAWINGS

The novel features believed characteristic of the invention are set forth in the appended claims. However, the invention itself, as well as a preferred mode of use, and further objectives and advantages thereof, will best be understood by reference to the following detailed description when read in conjunction with the accompanying drawings, wherein:

FIG. 1 illustrates a fragrance lamp, in accordance with the prior art;

FIG. 2 illustrates a decorative fragrance lamp, in accordance with the preferred embodiment of the present invention;

FIG. 3 illustrates a glass vessel of the decorative fragrance lamp of FIG. 2;

FIG. 4 illustrates a liner of the decorative fragrance lamp of FIG. 2;

FIGS. 5A through 5E illustrate a process for utilizing the decorative fragrance lamp of FIG. 2; and

FIG. 6 illustrates a high-level flowchart of a process for providing a decorative fragrance lamp, in accordance with the preferred embodiment of the present invention.

### DETAILED DESCRIPTION OF THE PREFERRED EMBODIMENT

Reference will now be made to the following detailed description of the preferred and alternate embodiments of the present invention. Those skilled in the art will recognize that the present invention provides many inventive concepts and novel features, that are merely illustrative, and are not to be construed as restrictive. Accordingly, the specific embodiments discussed herein are given by way of example and do not limit the scope of the present invention.

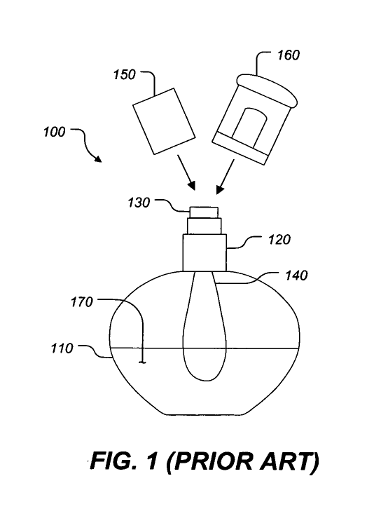

Referring now to FIG. 1 in the drawings, a fragrance lamp 100 according to the prior art is illustrated. Prior-art fragrance lamp 100 includes a glass base 110, a ring 120, a burner 130, a wick 140, a cap 150, a shade 160, and a fuel 170. The bottom portion of ring 120 is coupled directly to glass base 110 and includes a rubber washer to provide a seal between ring 120 and glass base 110. Ring 120 is typically made of a metallic material and does not provide an adequate seal when coupled to glass base 110, without the use of the rubber washer. Burner 130 is coupled to wick 140 and is a removable assembly that is attachable to the top portion of ring 120. The removable burner 130 and wick 140 assembly may be removed to add fuel 170 to glass base 110 via the opening in the top portion of ring 120.

Prior-art fragrance lamp 100 may be used by removing cap 150 from ring 120 and lighting burner 130 with a match or a lighter. Wick 140, which is soaked in fuel 170, provides burner 130 with fuel 170 to produce a flame. After a few minutes the flame, which is burning on burner 130, is blown out and shade 160 is placed over burner 130 and ring 120. Burner 130 remains hot and enables a catalytic burner process which draws fuel 170 through wick 140 to burner 130 and releases fuel 170 into the air. Fuel 170 may contain a particular fragrance which is released through the catalytic burner process.

One of the major problems associated with prior-art fragrance lamp 100 is that fuel 170 must be contained in glass base 110. This limitation greatly reduces the usability of prior-art fragrance lamp 100 and the aesthetic appearance of glass basses associated with prior-art fragrance lamp 100. In addition, the interior portion of glass base 110 must remain free of any image or design elements, because fuel 170 would affect the physical and visual appearance of these elements by degrading, eroding, or otherwise adversely affecting the image or design properties.

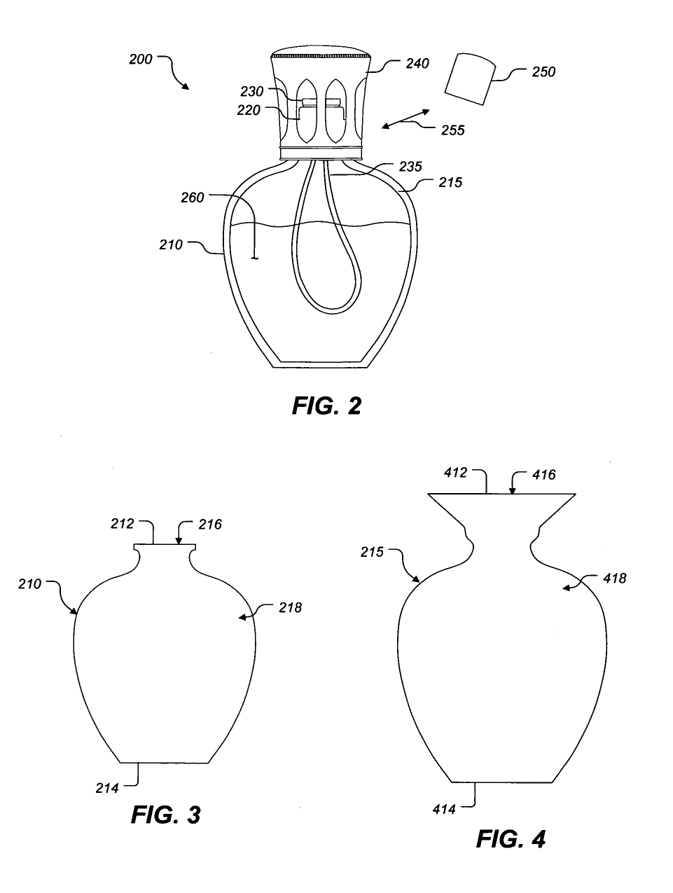

Referring now to FIG. 2 in the drawings, the preferred embodiment of a decorative fragrance lamp 200 according to the present invention is illustrated. Decorative fragrance lamp 200 comprises a glass vessel 210, a liner 215, a ring 220, a catalytic stone burner 230, a wick 235, a decorative crown 240, a cap 250, and a fuel 260. As will be explained below in greater detail, glass vessel 210 is accumulated on the end of a glass blowing element to form glass vessel 210 during the glass blowing process. In addition, the interior portion of glass vessel 210 is capable of being reverse hand-painted, as described in more detail below. The very essence and nature of the reverse hand-painted glass vessel provides for a more decorative and aesthetically pleasing appearance over the prior-art fragrance lamps.

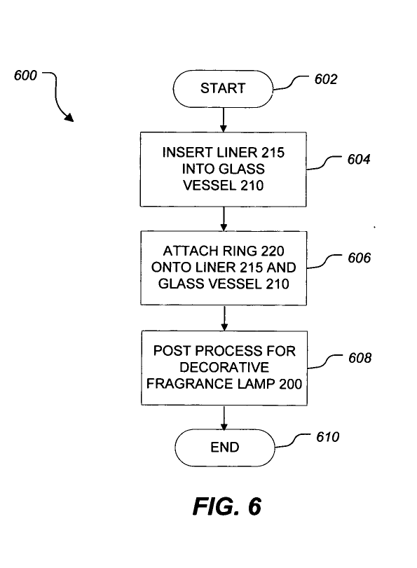

In the preferred embodiment of the present invention, liner 215 is capable of being inserted into glass vessel 210 and further capable of being filled with fuel 260. As will be explained below in greater detail with respect to FIG. 4 and FIG. 6, liner 215 provides for a protective barrier between the interior portion of glass vessel 210 and fuel 260. This protective barrier formed by liner 215 allows for the addition of fuel 260 into the interior portion of the glass vessel 210 without making direct contact with the reverse hand-painted image. Without the protective barrier formed by liner 215, fuel 260 would make direct contact with the image and fuel 260 would affect the physical and visual appearance of the reverse hand-painted glass vessel by degrading, eroding, or otherwise adversely affecting the image properties. The non-direct contact created by liner 215 separates fuel 260 from the image and allows the image to retain its original image properties, thereby greatly increasing the usability of decorative fragrance lamp 200.

In an alternate embodiment of the present invention, a protective barrier may be formed by a liquid barrier applied to the reverse hand-painted image of the interior portion of glass vessel 210. This liquid barrier may be applied to the image to provide a waterproof seal between the interior portion of glass vessel 210 and fuel 260. In addition, the liquid barrier may be made from, for example, polymer, silicone, waterproof sealant, or any other chemical compound or mixture of compounds formed to create a protective barrier.

As will be explained below in greater detail with respect to FIG. 6, liner 215 extends above glass vessel 210 and is coupled to glass vessel 210 via ring 220, thereby forming a waterproof enclosure for fuel 260. Ring 220 is configured with a pass-through portion extending from the top portion of ring 220 to the bottom portion of ring 220. In this manner, ring 220 is configured with only a side portion extending on all sides of ring 220 and may be for example in the form of a circle, a square, a rectangle, an octagon, or any other like shape. The bottom portion of ring 220 is attachably connected to liner 215 and glass vessel 210 by, for example, crimping, snapping, rotateably fastening, or otherwise affixing ring 220 over liner 215 and glass vessel 210. In addition, or as an alternative, a rubber washer may be used in association with ring 220 to provide a fluid-tight seal or otherwise waterproof decorative fragrance lamp 200, if so desired.

The bottom portion of catalytic stone burner 230 is coupled with wick 235 that provides fuel 260 for burning decorative fragrance lamp 200. The bottom portion of catalytic stone burner 230 is further capable of attaching to the interior of the top portion of ring 220. As will be explained below in greater detail with respect to FIG. 6, the ability to remove and re-insert the catalytic stone burner 230 and wick 235 assembly into ring 220 provides an opening to fill liner 215 with fuel 260. In the preferred embodiment of the present invention, fuel 260 may be a mixture of isopropyl alcohol, water, and a fragrance, for example, 93% isopropyl alcohol, 6% water, and 1% fragrance, by volume. It is understood that this fuel mixture is given by way of example, and that the present invention is not limited to this exact mixture of isopropyl alcohol, water, and fragrance. Moreover, the present invention contemplates a larger, smaller, or any number of portions of isopropyl alcohol, water, and fragrance, according to particular needs. In addition, the present invention contemplates any type of fuel necessary for burning decorative fragrance lamp 200.

Continuing with reference to FIG. 2, cap 250 is capable of attaching over the exterior of the top portion of ring 220 and provides a multi-functional feature for use with decorative fragrance lamp 200. Cap 250 may be placed on ring 220 for storage purposes or for snuffing out the catalytic burning process as shown by bi-directional arrow 255 and as described below in more detail. Decorative crown 240 is configured to be placed on top of decorative fragrance lamp 200 and in particular over ring 220 and catalytic stone burner 230. Decorative crown 240 comprises a plurality of venting ports on the side portions and top portion of decorative crown 240. These venting ports provide for the diffusion of fragrances from catalytic stone burner 230 and enhance the decorative appearance of decorative fragrance lamp 200. Although decorative crown 240 is shown and described comprising a plurality of venting ports, the present invention contemplates more, fewer or any number of venting ports, according to particular needs.

Although decorative fragrance lamp 200 is shown and described as having a shape substantially similar to a vase, it should be understood that the present invention is not limited to a decorative fragrance lamp in the form of a vase. Other types of shapes and forms may be used for decorative fragrance lamp 200, including lamps, wine decanters, candle stands, snow globes, aquariums or fish bowls, or the like. For the sake of simplicity, only a decorative fragrance lamp shaped in the form of a vase is shown and discussed herein. However, for the purposes of defining the scope of the claims of the present invention, the term decorative fragrance lamp and any other term used to denote decorative fragrance lamp 200 should be construed broadly to include substantially any shape or form of a decorative fragrance lamp capable of being reverse hand-painted.

Referring now to FIG. 3 in the drawings, the preferred embodiment of a glass vessel 210 according to the present invention is illustrated. Glass vessel 210 comprises a top portion 212 and a base portion 214. Top portion 212 of glass vessel 210 provides an access port 216 into a void space 218 of the interior portion of glass vessel 210. Moreover, top portion 212 and access port 216 of glass vessel 210, are configured to receive the attachment of liner 215 and ring 220.

In the preferred embodiment of the present invention, the interior portion of glass vessel 210 is capable of being reverse hand-painted through access port 216. In addition, or as an alternative, the exterior portion of glass article 210 and the exterior portion of liner 215 are also capable of being hand-painted. Although a preferred embodiment has been described as reverse hand-painting, it should be understood that an image may be disposed on the interior or exterior portions of glass vessel 210 and liner 215 using reverse hand-painting, hand-painting, spray-painting, machine-painting, stickers, labels, etching, or the like.

In the preferred embodiment of the present invention, glass vessel 210 is formed using glass blowing techniques. To further explain the glass blowing techniques to form glass vessel 210, an example is now given. In the following example, the glass material comprising glass vessel 210 is accumulated on the end of a glass blowing element to provide for the forming of glass vessel 210. The heated glass material, accumulated on the end of the glass blowing element, is blown to form glass vessel 210, which is preferably a substantially hollow object. Glass vessel 210 may be blown, using translucent glass material or substantially transparent glass material. In addition or as an alternative, glass vessel 210 may be blown using opaque glass material, colored glass material, or other glass material. Additionally, a first portion of glass vessel 210 may be blown using glass blowing techniques that provide for a first glass material, and a second portion of glass vessel 210 may be blown using glass blowing techniques that provide for a second glass material, thereby creating a multi-glass vessel 210 using at least one of a plurality of glass materials.

In an alternate embodiment of the present invention, a glass blowing mold (not shown) may be used with glass blowing techniques to form glass vessel 210. To further explain the operation of a mold, an example is now given. In the following example, glass vessel 210 may be blown using a glass blowing element within a first glass blowing mold comprising a sphere-shaped interior. As glass vessel 210 is blown through the glass blowing element and makes contact with the interior sphere-shaped first glass blowing mold, glass vessel 210 is formed and replicates the shape of the first glass blowing mold. Accordingly, different glass blowing molds may be used to achieve different shapes or appearances of glass vessel 210. For example, a second glass blowing mold comprising a different sphere-shaped interior may be employed to create or enhance glass vessel 210. Those skilled in the art will recognize that the glass blowing mold comprising a sphere-shaped interior is given by way of example and that the present invention is not limited to the use of glass blowing molds comprising a sphere-shaped interior.

In another alternate embodiment of the present invention, the glass material comprising glass vessel 210 may be inserted into a second blown glass vessel, thereby forming a seamless, one-piece glass vessel comprising two or more glass vessels, as shown and described in related U.S. patent application Ser. No. 11/151,367, filed 13 JUNE 2005, entitled “APPARATUS AND METHOD FOR PROVIDING THE ATTACHMENT OF A REVERSE HAND-PAINTED DECORATIVE ART WITHIN A GLASS VESSEL.” application Ser. No. 11/151,367 is commonly assigned to the assignee of the present invention. Application Ser. No. 11/151,367 is hereby incorporated by reference for all purposes as if fully set forth herein.

It is understood that the glass blowing techniques used in association with the forming of glass vessel 210 are given by way of example only and should not be construed to limit the scope or type of glass blowing techniques in which the present invention may be implemented. In addition, the glass blowing element described in association with glass vessel 210 may be for example, a glass tube, a glass blowpipe, a handling rod, or the like. Additionally, while the forming of glass vessel 210 is shown and described as using a substantially manual technique, glass lathes or other types of mechanical assembly techniques are within the scope of the present invention.

Referring now to FIG. 4 in the drawings, the preferred embodiment of a liner 215 according to the present invention is illustrated. Liner 215 comprises a top portion 412 and a base portion 414. Top portion 412 of liner 215 provides an access port 416 into a void space 418 of the interior portion of liner 215. Void space 418 is capable of being filled with fuel 260, for example, isopropyl alcohol, oil, or any other fuel for burning catalytic stone burner 230 of decorative fragrance lamp 200.

In the preferred embodiment of the present invention, bottom portion 414 of liner 215 is capable of being inserted into top portion 212 of glass vessel 210 through access port 216. After liner 215 is inserted into glass vessel 210, top portion 412 of liner 215 is placed overtop portion 212 of glass vessel 210. Air is blown into access port 416 of liner 215 filling void space 418 of liner 215 with air, thereby expanding liner 215 to conform to void space 218 of glass vessel 210. Ring 220 is placed over liner 215 and top portion 212 of glass vessel 210 and fixedly attached thereto. It is recalled from the above discussion that a rubber washer may be inserted between ring 220 and liner 215 and glass vessel 210, if so desired. Although a rubber washer is described with the sealing of ring 220, liner 215 and glass vessel 210, the present invention contemplates any type of washer, for example, plastic, cork, silicone, foam, or any other type of washer, according to particular needs.

It is recalled from the above discussion that liner 215 provides for a protective barrier between the interior portion of glass vessel 210 and fuel 260. It is also recalled that this protective barrier formed by liner 215 allows for the addition of fuel 260 into the interior portion of glass vessel 210 without making direct contact with the reverse hand-painted image. In the preferred embodiment of the present invention, liner 215 may be formed using a 60 gauge nylon laminated to a 1.5 mil poly film. In addition, liner 215 may comprise two sheets of poly film wherein the edge is sealed using a heating sealing method to form a one piece liner 215, as shown in FIG. 4. Although a preferred embodiment of liner 215 has been described as using a 60 gauge nylon laminated to a 1.5 mil poly film, it should be understood that the present invention is not limited to the 60 gauge nylon laminated to a 0.1.5 mil poly film. In addition, the present invention contemplates heavier, lighter or any weight of poly film, according to particular needs.

Additionally, it should be understood that the present invention is not limited to poly film. Other types of material may be used to form liner 215, for example, a plastic material, a silicone material, a rubber material or any other like material for providing a waterproof self-encapsulated protective liner for fuel 260. It is also understood that for simplicity and clarity, only so much of the construction of liner 215 as is unique to the present invention or necessary for an understanding of the present invention is shown and described. Moreover, although a preferred embodiment of liner 215 has been described as being formed and sealed using a heating sealing method. The present invention contemplates other formation and sealing methods to form liner 215 as a protective barrier, for protecting the interior surface of glass vessel 210.

In an alternate embodiment of the present invention, liner 215 may be formed using transparent material, multicolored material, decorative material, or any other type of material to provide liner 215 with a visible or substantially invisible appearance, according to particular needs. In an alternate embodiment, fuel 260 may be for example a colored fluid and may include particle matter to accentuate the decorative nature of glass vessel 210.

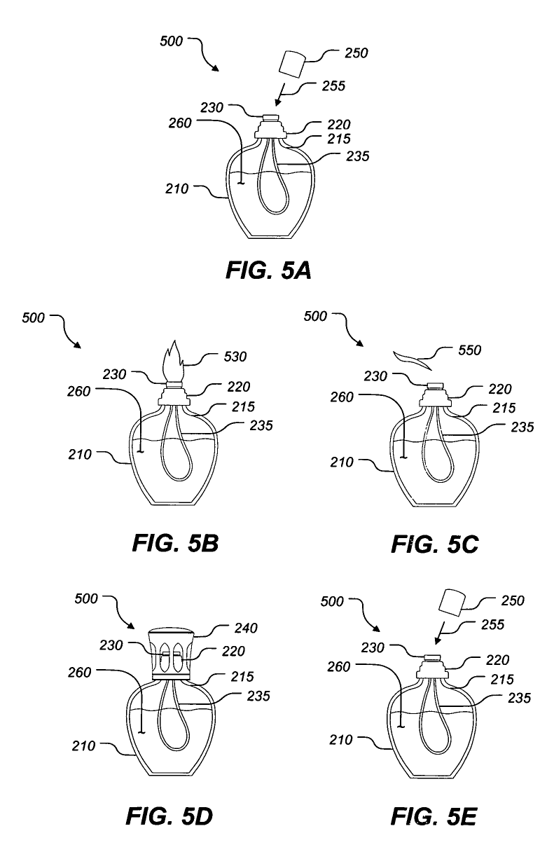

Referring now to FIGS. 5A through 5E in the drawings, the preferred embodiment of a process 500 for utilizing the decorative fragrance lamp 200 of FIG. 2 according to the present invention is illustrated. In the preferred embodiment of the present invention, fuel 260 is added to liner 215 of glass vessel 210. It is recalled from the above discussion that without a protective barrier formed by liner 215, fuel 260 would make direct contact with an image disposed on the interior portion of glass vessel 210 and fuel 260 would affect the physical and visual appearance of the reverse hand-painted glass vessel by degrading, eroding, or otherwise adversely affecting the image properties. The non-direct contact created by liner 215 separates fuel 260 from the image and allows the image to retain its original image properties.

As shown in FIG. 5A, after fuel 260 is added to liner 215 of glass vessel 210, the catalytic stone burner 230 and wick 235 assembly is inserted into the opening of the top portion of ring 220. Cap 250 is placed over the exterior of the top portion of ring 220 and fuel 260 is soaked into wick 235 for a predetermined amount of time. Then in FIG. 5B, cap 250 is removed from ring 220 and catalytic stone burner 230 is lit using a match, lighter, or other lighting device. Flame 530 is allowed to burn for a predetermined time to activate the catalytic burner process.

Then in FIG. 5C, flame 530 is extinguished and fragrance 550 is automatically released from catalytic stone burner 230. The catalytic burner process converts fuel 260 to ozone and anions (negatively charged ions) which are released into the air via catalytic stone burner 230. These ozone molecules bind with airbourne particles and odors, and purify the air by essentially eliminating the un-purified airbourne particles and odors. Next in FIG. 5D, decorative crown 240 is placed over ring 220 and catalytic stone burner 230. Decorative crown 240 comprises a plurality of venting ports which provide for the emanation of fragrance 550 from catalytic stone burner 230.

The process ends in FIG. 5E, in which the decorative crown 240 is removed from decorative fragrance lamp 200 and cap 250 is replaced on ring 220 to snuff out the catalytic burner process.

Referring now to FIG. 6 in the drawings, the preferred embodiment of a high-level flowchart 600 of a process for providing a decorative fragrance lamp 200 according to the present invention is illustrated. Flowchart 600 starts at step 602 with a formed glass vessel 210, which is substantially a hollow object of substantially any shape, such as a cylinder, sphere, or the like.

Next, in step 604, liner 215 is inserted into access port 216 of glass vessel 210. After liner 215 is inserted into glass vessel 210, top portion 412 of liner 215 is placed over top portion 212 of glass vessel 210, and liner 215 is expanded to conform to void space 218 of glass vessel 210.

Next, in step 606, ring 220 is attached to glass vessel 210. It is recalled from the above discussion that a rubber washer may be used with ring 220, to ensure a waterproof seal. If a rubber washer is to be used, then it is inserted into ring 220 during this process. Ring 220 is then placed over liner 215 and top portion 212 of glass vessel 210 and fixedly attached thereto. Liner 215 is trimmed around ring 220 and if necessary, may be heated to shrink fit around glass vessel 210 and ring 220.

The process continues in step 608, in which an appropriate post process is selected for decorative fragrance lamp 200. Such as for example, packaging decorative fragrance lamp 200 individually, in bulk, in a kit, or any other like post processes. In the preferred embodiment of the present invention, fragrance lamp 200 may be provided in a kit packaged in a presentation case and including fragrance lamp 200, a fragrance container 510, according to particular needs. The process ends in step 616, which is to ship decorative fragrance lamp 200, either, individually, in bulk, or in a kit to the customer, according to particular needs.

While the exemplary embodiments of the present invention have been shown and described, it will be understood that various changes and modifications to the foregoing embodiments may become apparent to those skilled in the art without departing from the spirit and scope of the present invention. Accordingly, the invention is not limited to the embodiments disclosed, but rather by the appended claims and their equivalents.

What is claimed is:

1. A decorative fragrance lamp, comprising:
at least one glass vessel;
at least one access port associated with an interior portion of the at least one glass vessel;
a protective barrier disposed within the at least one glass vessel for protecting the interior surface of the at least one glass vessel; and
a ring coupled to the protective barrier and the at least one glass vessel.

2. The decorative fragrance lamp according to claim 1, further comprising:
an image disposed on an interior surface of the at least one glass vessel.

3. The decorative fragrance lamp according to claim 2, wherein the image is a reverse hand-painted image painted through the at least one access port.

4. The decorative fragrance lamp according to claim 1, wherein the ring is coupled to a washer prior to being coupled to the liner and the at least glass vessel to form a fluid-tight seal.

5. The decorative fragrance lamp according to claim 1, wherein the protective barrier is a liner.

6. The decorative fragrance lamp according to claim 5, further comprising:
a fuel disposed in the liner.

7. The decorative fragrance lamp according to claim 6, further comprising:
a catalytic stone burner and wick assembly capable of being inserted into the at least one glass vessel through the top portion of the ring.

8. The decorative fragrance lamp according to claim 7, wherein the catalytic stone burner and wick assembly is capable of creating a catalytic burning process when ignited.

9. The decorative fragrance lamp according to claim 1, further comprising:
a decorative crown comprising a plurality of venting ports; and
a cap capable of coupling to the exterior top portion of the ring and capable of snuffing out the catalytic burning process of the catalytic stone burner.

10. The decorative fragrance lamp according to claim 1, wherein the protective barrier is formed by a liquid barrier applied to the reverse hand-painted image of the interior surface of the at least one glass vessel.

11. A painted vessel, comprising:
a hollow article;
at least one access port for providing access to the interior of the hollow article;
an image disposed on the interior surface of the hollow article; and
a protective barrier disposed within the hollow article to protect the image.

12. The painted vessel according to claim 11, wherein the hollow article is formed from blown glass.

13. The painted vessel according to claim 11, wherein the image is a reverse hand-painted image painted through the at least one access port.

14. The painted vessel according to claim 11, wherein the protective barrier is a removable liner.

15. The painted vessel according to claim 14, further comprising:
a ring for sealing the liner to the hollow article;
a fuel disposed in the liner; and
a wick assembly capable of being inserted into the hollow article through the top portion of the ring.

16. The painted vessel according to claim 15, wherein the wick assembly is capable of creating a catalytic burning process when ignited.

17. The painted vessel according to claim 16, further comprising:
a decorative crown comprising a plurality of venting ports, the crown being adapted to fit over the hollow article; and
a cap capable of coupling to the exterior top portion of the ring and capable of snuffing out the catalytic burning process of the catalytic stone burner.

18. A method of making a decorative fragrance lamp, comprising the steps of:
providing a vessel;
inserting a liner through the access port of the vessel; and
disposing a fragrance material within the liner.

19. The method according to claim 18, further comprising the step of:
decorating the vessel by reverse hand-painting an image on an interior surface of the vessel.

20. The method according to claim 18, further comprising the steps of:
providing a wick assembly; and
inserting the wick assembly into the fragrance material, so as to allow the fragrance material to be selectively diffused in the atmosphere.
